(19) United States
(12) Patent Application Publication
(10) Pub. No.: US 2017/0147896 A1
(43) Pub. Date: May 25, 2017

(54) METHOD, DEVICE, AND STORAGE MEDIUM FOR FEATURE EXTRACTION

(71) Applicant: Xiaomi Inc., Beijing (CN)

(72) Inventors: Fei Long, Beijing (CN); Zhijun Chen, Beijing (CN); Tao Zhang, Beijing (CN)

(21) Appl. No.: 15/360,021

(22) Filed: Nov. 23, 2016

(30) Foreign Application Priority Data
Nov. 25, 2015 (CN) 201510829071.7

(51) Int. Cl. G06K 9/46; G06T 7/00

(52) U.S. Cl. CPC G06K 9/4642; G06T 7/0081

(57) ABSTRACT

A method and a device for feature extraction are provided in the disclosure. The method may include: partitioning an image into a plurality of blocks, each of the blocks including a plurality of cells; performing a sparse signal decomposition on the cells using a predetermined dictionary to obtain sparse vectors respectively corresponding to the cells; and extracting an image Histogram of Oriented Gradient (HOG) feature of the image according to the sparse vectors.

### CROSS-REFERENCE TO RELATED APPLICATION

This application is based upon and claims priority to Chinese Patent Application No. 201510829071.7, filed on Nov. 25, 2015, the entire contents of which are incorporated herein by reference.

### FIELD

The present disclosure generally relates to image processing and, more particularly, to a method, device, and computer-readable storage medium for feature extraction.

### BACKGROUND

Image detection and recognition technology is an important research field in computer vision. The most common way in the image detection and recognition technology is to extract a feature of an image to detect and recognize the image.

In conventional technology, an image is detected and recognized by extracting a Histogram of Oriented Gradient (HOG) feature of the image. To extract the HOG feature of an image, the gradient of each pixel in the image is calculated. The image is partitioned into a plurality of cells, each of which includes a plurality of pixels. Every n adjacent cells form a block. A gradient histogram for all pixels in each of the cells is obtained, and an HOG feature of each of the blocks is obtained according to the gradient histograms of all the cells in the blocks. The HOG features of all the blocks in the image are assembled to obtain the HOG feature of the image.

### SUMMARY

According to a first aspect of the present disclosure, there is provided a method for feature extraction, comprising: partitioning an image into a plurality of blocks, each of the blocks including a plurality of cells; performing a sparse signal decomposition on the cells using a predetermined dictionary to obtain sparse vectors respectively corresponding to the cells; and extracting an image Histogram of Oriented Gradient (HOG) feature of the image according to the sparse vectors.

According to a second aspect of the present disclosure, there is provided a device for feature extraction, comprising: a processor; and a memory storing instructions that, when executed by the processor, cause the processor to: partition an image into a plurality of blocks, each of the blocks including a plurality of cells; perform a sparse signal decomposition on the cells using a predetermined dictionary to obtain sparse vectors respectively corresponding to the cells; and extract an image Histogram of Oriented Gradient (HOG) feature of the image according to the sparse vectors.

According to a third aspect of the present disclosure, there is provided a non-transitory computer-readable storage medium having stored therein instructions that, when executed by a processor, cause the processor to: partition an image into a plurality of blocks, each of the blocks including a plurality of cells; perform a sparse signal decomposition on the cells using a predetermined dictionary to obtain sparse vectors respectively corresponding to the cells; and extract an image Histogram of Oriented Gradient (HOG) feature of the image according to the sparse vectors.

It is to be understood that both the forgoing general description and the following detailed description are exemplary only, and are not restrictive of the present disclosure.

### BRIEF DESCRIPTION OF THE DRAWINGS

The accompanying drawings, which are incorporated in and constitute a part of this specification, illustrate embodiments consistent with the invention and, together with the description, serve to explain the principles of the invention.

FIG. 1 is a flow chart showing a method for feature extraction according to an exemplary embodiment.

FIG. 2A is a flow chart showing a method for feature extraction according to another exemplary embodiment.

FIG. 2B is a schematic diagram showing an image partition according to an exemplary embodiment.

FIG. 2C is a schematic diagram showing an image partition according to another exemplary embodiment.

FIG. 2D is a schematic diagram showing adjusting pixels of a cell according to an exemplary embodiment.

FIG. 2E is a schematic diagram showing assembling HOG features of blocks according to an exemplary embodiment.

FIG. 3A is a flow chart showing a method for feature extraction according to another exemplary embodiment.

FIG. 3B is a schematic diagram showing assembling HOG features of blocks according to another exemplary embodiment.

FIG. 4 is a block diagram showing a device for feature extraction according to an exemplary embodiment.

FIG. 5 is a block diagram showing a device for feature extraction according to another exemplary embodiment.

FIG. 6 is a block diagram showing an example of a second assembling sub-module shown in FIG. 5.

FIG. 7 is a block diagram showing a device for feature extraction according to another exemplary embodiment.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise described. The implementations set forth in the following description of exemplary embodiments do not represent all implementations consistent with the invention. Instead, they are merely examples of device and methods consistent with aspects related to the invention as recited in the appended claims.

Methods consistent with the present disclosure can be implemented in, for example, a hardware device for pattern recognition, such as a terminal.

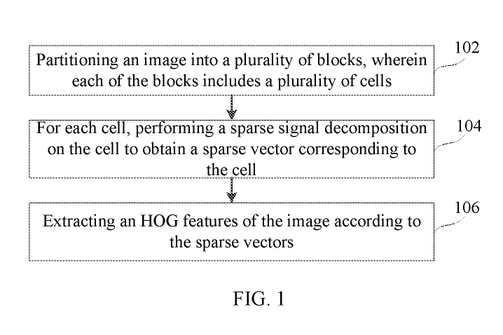

FIG. 1 is a flow chart showing a method for feature extraction according to an exemplary embodiment. As shown in FIG. 1, at 102, an image is partitioned into a plurality of blocks. Each of the blocks includes a plurality of cells.

At 104, for each cell, a sparse signal decomposition is performed on the cell using a predetermined dictionary D to obtain a sparse vector corresponding to the cell. The predetermined dictionary D is a dictionary calculated by applying an iterative algorithm to sample images. The sparse signal decomposition refers to converting a given observed signal into a sparse vector according to the predetermined dictionary D. Several elements in the sparse vector are zero. In the present disclosure, pixels in a cell constitute a given observed signal and are converted into a corresponding sparse vector according to the predetermined dictionary D. As such, sparse vectors each corresponding to one of the cells are obtained.

At 106, a Histogram of Oriented Gradient (HOG) feature of the image is extracted according to the sparse vectors.

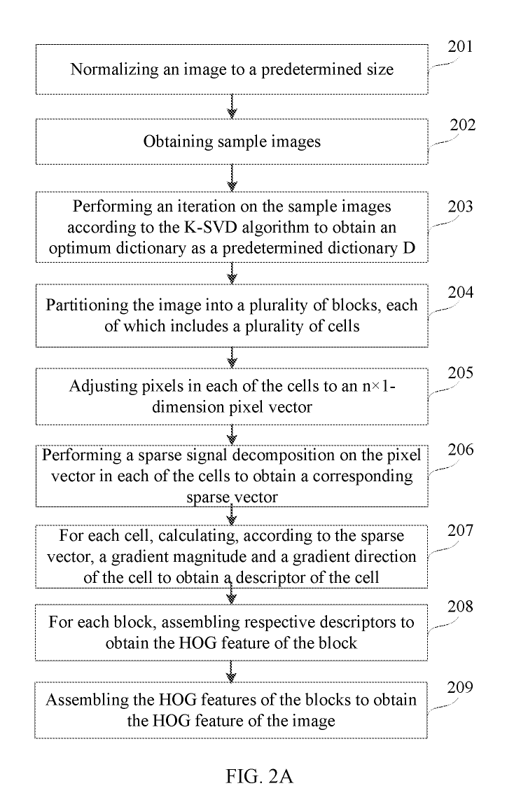

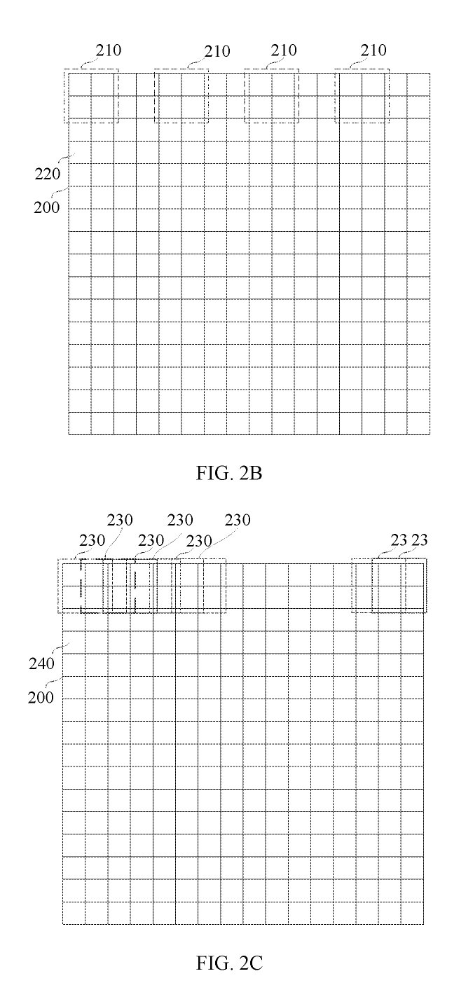

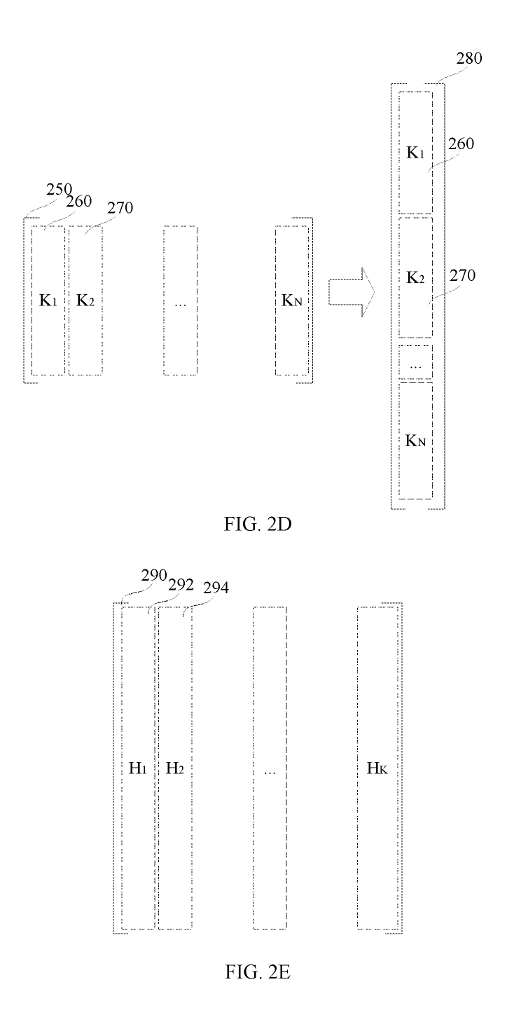

FIG. 2A is a flow chart showing a method for feature extraction according to another exemplary embodiment. As shown in FIG. 2A, at 201, a target image is normalized to obtain a normalized image of a predetermined size. Pattern recognition sometimes involves feature extraction for a plurality of images. Before performing the feature extraction, target images can be normalized to the same predetermined size to facilitate processing. Nevertheless, normalizing the target image can be optional. For simplification, an image subject to the feature extraction, whether normalized or not, will be referred to hereinafter as an “image.”

At 202, sample images are obtained. The sample images include a plurality of image sets of several categories, such as, for example, a face category, a body category, and/or a vehicle category. The sample images can be obtained from a sample image library. In some embodiments, the sample images can also be normalized to the predetermined size.

At 203, an optimum dictionary is obtained by performing an iteration on the sample images according to the K-means Singular Value Decomposition (K-SVD) algorithm. The obtained optimum dictionary is used as the predetermined dictionary D. Specifically, the optimum dictionary can be obtained using the following formula:

min(R,D) ∥Y−DR∥_{F}² subject to ∀i,∥mᵢ∥₀≦T₀

where R=[r₁, r₂, . . . , r_{c}] denotes a sparse coefficient matrix of C sample images, Y denotes the sample images of all categories, ∥•∥₀ denotes calculating the number of non-zero elements in a vector, T₀ denotes a predefined sparse upper limit, and ∥•∥₅ denotes a square root of a sum of squares of elements of a vector.

With the K-SVD algorithm, dictionary learning can be implemented in the sample images through an iterative process. That is, sparse representation coefficients are used to update atoms in a dictionary and, through continuous iteration, a set of dictionary atoms, which can reflect the image feature, are eventually obtained as the predetermined dictionary D. An atom as used herein refers to an element of a dictionary.

The iterative process of the K-SVD algorithm is described as follows. Assume there are X categories of sample images, and the i-th category includes Nᵢ sample images. All the sample images of the i-th category are represented by a matrix Yᵢ=[yᵢₗ, . . . , y_{iN}_{ᵢ}] and the sample images of all categories are represented by Yᵢ=[Y₁, . . . , Yₓ]. Learning in the sample images can be conducted by substituting this Y matrix into the formula above, such that the optimum predetermined dictionary D can be obtained.

At 204, the image is partitioned into a plurality of blocks, each of which includes a plurality of cells. For example, a block can include four adjacent cells arranged in a 2×2 array. In some embodiments, the image is first partitioned into a plurality of blocks, and then each of the blocks is partitioned into a plurality of cells. In some embodiments, the image is first partitioned into a plurality of cells, and then adjacent cells are combined into a block. In some embodiments, blocks do not overlap with each other. Alternatively, adjacent blocks can overlap with each other.

FIG. 2B schematically illustrates an example of partitioning an image 200 of 128 pixels×128 pixels. As shown in FIG. 2B, the image 200 is first partitioned into non-overlapping blocks 210 each having 16 pixels×16 pixels, and then each of the blocks 210 is partitioned into cells 220 each having 8 pixels×8 pixels. Thus, as shown in FIG. 2B, the image 200 is partitioned into 8×8=64 non-overlapping blocks 210, and each of the blocks 210 includes 2×2=4 cells.

FIG. 2C schematically illustrates another example of partitioning the image 200 of 128 pixels×128 pixels. As shown in FIG. 2C, the image 200 is first partitioned into overlapping blocks 230 each having 16 pixels×16 pixels, and then each of the blocks 230 is partitioned into cells 240 each having 8 pixels×8 pixels. Thus, as shown in FIG. 2C, the image 200 is partitioned into 16×16=256 overlapping blocks 230, and each of the blocks 230 includes 2×2=4 cells.

At 205, pixels in each of the cells are adjusted to an n×1-dimensional vector, also referred to as a pixel vector. That is, after the image is partitioned, the pixels in each of the cells can be considered as a matrix, which can be adjusted to an n×1-dimensional pixel vector. FIG. 2D schematically illustrates an example of adjusting a matrix 250 corresponding to a plurality of pixels. As shown in FIG. 2D, the second column K₂ 270 in the matrix 250 is cascaded to follow the first column K1 260, and the third column (not shown in FIG. 2D) in the matrix 250 is cascaded to follow the second column K₂ 27, and so on. As shown in FIG. 2D, the matrix 250 is adjusted to an n×1-dimensional pixel vector 280.

At 206, the pixel vector in each of the cells is subject to a sparse signal decomposition to obtain a corresponding sparse vector. The sparse signal decomposition can be performed using the following formula:

min (x) ∥x∥₁ subject to y=Dx ,

where y denotes the pixel vector in a cell, which is used as a given observed signal, x is the sparse vector obtained by performing the sparse decomposition on y with the predetermined dictionary D, and ∥x∥₁ is the sum of the absolute values of the elements in the sparse vector x. Each sparse vector is an m×1-dimensional vector, and the predetermined dictionary D is an n×m matrix.

At 207, for each cell, gradient magnitudes and gradient directions of the cell are calculated according to the corresponding sparse vector to obtain a descriptor of the cell. A transverse gradient and a longitudinal gradient of each of the pixels in each cell, after the sparse signal decomposition, are calculated using a gradient operator. That is, for each element of the sparse vector corresponding to a cell, a transverse gradient and a longitudinal gradient are calculated using the gradient operator.

For example, common gradient operators are shown in Table 1 below:

TABLE 1

| | | Non- | Attention | | |
|---|---|---|---|---|---|
| Mask | Central | central | correction | | |
| type | vector | vector | vector | Diagonal | Sobel operator |
| Oper- ator | [1 0 −1] | [1 −1] | [1 8 0 −8 −1] | $( \begin{matrix}0 & 1 \\ - 1 & 0\end{matrix} )$ $( \begin{matrix}1 & 0 \\ 0 & - 1\end{matrix} )$ | $( \begin{matrix}1 & 0 & - 1 \\ 2 & 0 & - 2 \\ 1 & 0 & 1\end{matrix} )$ |

Any gradient operator in Table 1 or a suitable gradient operator not listed in Table 1 can be used to calculate the gradients of the pixels in the cells.

Assuming that the transverse gradient and the longitudinal gradient of an element (k, l) in the sparse vector are H(k, l) and V(k, l), respectively, then the gradient direction and the gradient magnitude corresponding to the element can be calculated using formulae (1) and (2) below:

θ(k, l)=tan⁻¹ [V(k, l)/H(k, l)] (1)

m(k, l)=[H(k, l)²+V(k, l)²]^{1/2} (2)

where θ(k, l) is the gradient direction of the element (k, l) in the sparse vector, and m(k, l) is the gradient magnitude of the element (k, l).

The gradient direction θ(k, l ) of an element is in the range from −90 degrees to 90 degrees. This 180-degree range can be partitioned evenly into z portions. For each cell, all the elements in the corresponding sparse vector in each of the z portions are counted according to the gradient directions θ(k, l) using the gradient magnitudes m(k, l) as weights to obtain a z-dimensional vector. This z-dimensional vector is the descriptor corresponding to the cell.

For example, for a cell, the range for the gradient directions θ(x, y) is partitioned evenly into 9 portions, where the angle corresponding to each of the portions is 20 degrees. The elements in the sparse vector corresponding to the cell are counted in respective portions of 20-degrees using the gradient magnitudes m(k, l) as weights to obtain a 9-dimention vector for the cell.

At 208, for each block, the respective descriptors are assembled to obtain the HOG feature of the block. The descriptors corresponding to respective cells in a block can be cascaded, so that the HOG feature of the block can be a vector, where the dimension of the vector is the product of the dimension of the descriptor of one cell and the number of cells in the block.

For example, the descriptors in respective cells are 9-dimensional vectors, and each of the blocks includes four cells. The 9-dimensional descriptors in the four cells are cascaded to form a 36-dimensional vector, which is the HOG feature of the corresponding block.

At 209, the HOG features of respective blocks are assembled to obtain the HOG feature of the image. Specifically, the HOG features of respective blocks in the image are cascaded to form a matrix to obtain the HOG feature of the image, where each column of the matrix is the HOG feature of one block.

FIG. 2E schematically illustrates an example of cascading the HOG features of the blocks to form the HOG feature of an image including K blocks. Assume the HOG feature of the j-th block is Hⱼ (1≦j≦K), then the K HOG features are cascaded to form a matrix 290, where H₁ is placed at the first column 292 of the cascaded matrix 290, and H₂ is placed at the second column 294 of the cascaded matrix 290, and so on, as shown in FIG. 2E.

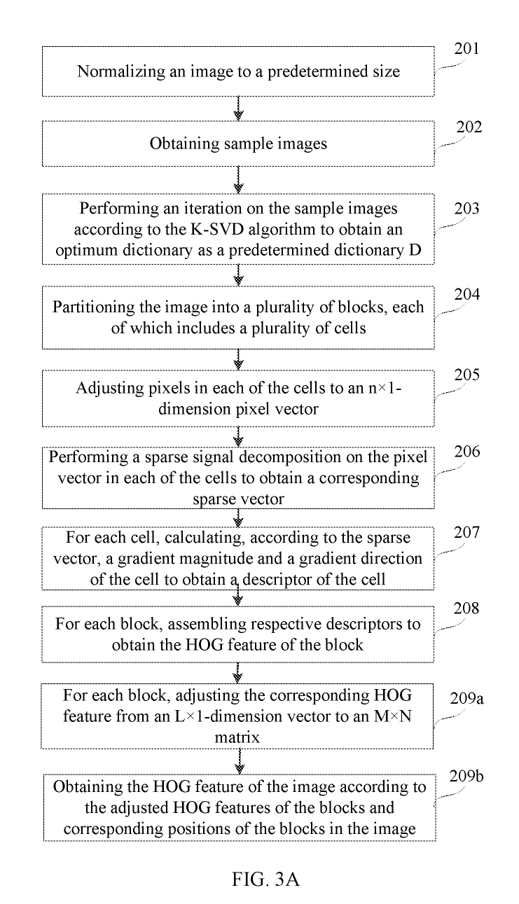

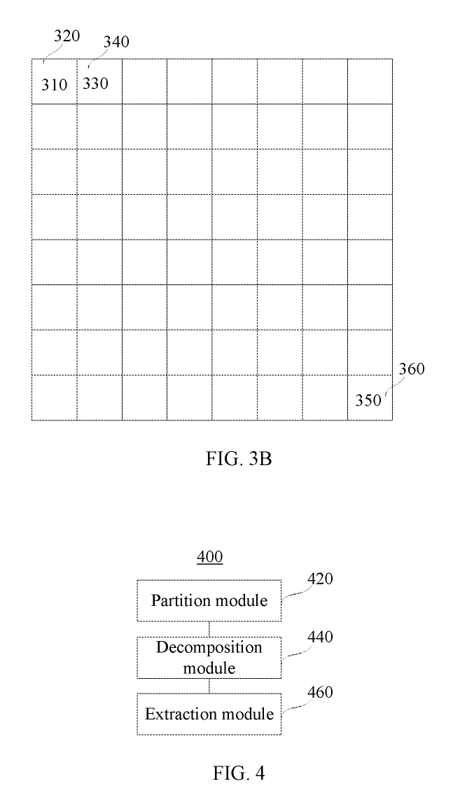

FIG. 3A is a flow chart showing a method for feature extraction according to another exemplary embodiment. In the exemplary method shown in FIG. 3A, the HOG features of the blocks in the image are arranged according to corresponding positions in the image. As shown in FIG. 3A, at 209a, for each block in the image, the corresponding HOG feature, which is an L×1-dimensional vector, is adjusted to an M×N matrix, where the block includes M×N pixels, and L=M×N. Specifically, the L×1-dimensional vector in each of the blocks is adjusted to a corresponding matrix according to the cells in the block, where each column of the corresponding matrix is a descriptor of one of the cells. Then the descriptors of the cell are adjusted according to the corresponding pixels to obtain an adjusted matrix, where each column of the adjusted matrix is the HOG feature corresponding to the pixels of the corresponding column in the corresponding block.

At 209b, the HOG feature of the image is obtained according to the adjusted HOG features of the blocks and corresponding positions of the blocks in the image. That is, the HOG features of the corresponding positions of the pixels in the image are obtained.

FIG. 3B schematically illustrates an example of assembling the HOG features of the blocks to form the HOG feature of the image including K blocks. The HOG features of respective blocks are Hⱼ (1≦j≦K). Each of the HOG features Hⱼ is adjusted to an M×N matrix. A matrix 310 obtained by adjusting the HOG feature H₁ is placed at the corresponding position of a first block 320 in the image, a matrix 330 obtained by adjusting the HOG feature H₂ is placed at the corresponding position of a second block 340 in the image, and so on, and a last matrix 350 obtained by adjusting the HOG feature H_{K} is placed at the corresponding position of a last block 360 in the image, as shown in FIG. 3B.

Exemplary devices consistent with the present disclosure will be described below. Operations of these exemplary devices are similar to the exemplary methods describe above, and therefore their detailed description is omitted here.

FIG. 4 is a block diagram illustrating a device 400 for feature extraction according to an exemplary embodiment. As shown in FIG. 4, the device 400 includes, but is not limited to, a partition module 420, a decomposition module 440, and an extraction module 460. The partition module 420 is configured to partition an image into a plurality of blocks, each of which includes a plurality of cells. The decomposition module 440 is configured to perform a sparse signal decomposition on each cell using a predetermined dictionary D to obtain a sparse vector corresponding to the cell. The predetermined dictionary D is a dictionary calculated by applying an iterative algorithm to sample images. The sparse signal decomposition refers to converting a given observed signal into a sparse vector, also referred to as a “sparse signal,” according to the predetermined dictionary D. The values of several elements in the sparse signal are zero. In the present disclosure, pixels in each of the cells constitute a given observed signal and are converted into a sparse signal corresponding to the cell. The extraction module 460 is configured to extract an HOG feature of the image according to the sparse vectors.

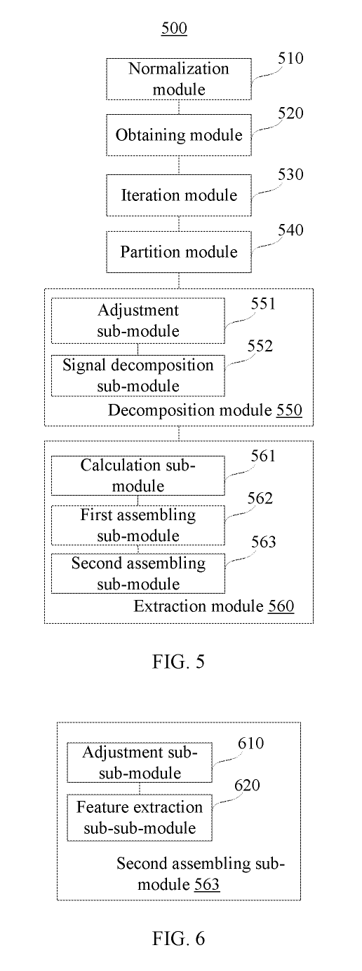

FIG. 5 is a block diagram showing a device 500 for feature extraction according to another exemplary embodiment. As shown in FIG. 5, the device 500 includes, but is not limited to a normalization module 510, an obtaining module 520, an iteration module 530, a partition module 540, a decomposition module 550, and an extraction module 560.

The normalization module 510 is configured to normalize a target image to obtain a normalized image of a predetermined size. In some scenarios, pattern recognition may involve feature extraction for a plurality of images, which can be normalized to the same predetermined size to facilitate processing. For simplification, an image subject to the feature extraction as described below, whether normalized or not, will be referred to as an “image.”

The obtaining module 520 is configured to obtain sample images, which include a plurality of image sets of several categories, such as, for example, a face category, a body category, and/or a vehicle category. The obtaining module 520 can obtain the sample images from a sample image library.

The iteration module 530 is configured to perform an iteration on the sample images according to the K-SVD algorithm to obtain an optimum dictionary as the predetermined dictionary D. Details about the iterative process using the K-SVD algorithm are described above with reference to FIG. 2A, and are not repeated here.

The partition module 540 is configured to partition the image into a plurality of blocks, each of which includes a plurality of cells. In some embodiments, the partition module 540 can first partition the image into a plurality of blocks, and then partition each of the blocks into a plurality of cells. Alternatively, the partition module 540 can first partition the image into a plurality of cells, and then combine adjacent cells into a block. For example, a block can include four adjacent cells arranged in a 2×2 array. The blocks may or may not overlap with each other.

The decomposition module 550 is configured to perform a sparse signal decomposition on each of the cells using the predetermined dictionary D to obtain sparse vectors respectively corresponding to the cells.

In some embodiments, as shown in FIG. 5, the decomposition module 550 includes an adjustment sub-module 551 and a signal decomposition sub-module 552. The adjustment sub-module 551 is configured to adjust pixels in each of the cells to an n×1-dimensional pixel vector. The signal decomposition sub-module 552 is configured to perform the sparse signal decomposition on the pixel vectors in the cells according to the predetermined dictionary D to obtain the sparse vectors corresponding to the cells respectively, using the following formula:

min(x) ∥x∥₁ subject to y=Dx

where y denotes the pixel vector in a cell, x denotes the sparse vector obtained by sparse processing y with the predetermined dictionary D, ∥x∥₁ denotes the sum of the absolute values of the elements of the sparse vector x, wherein each of the sparse vectors is an m×1-dimensional vector, and the predetermined dictionary D is an n×m matrix.

Specifically, for each of the cells in the image, the iteration module 530 calculates an optimum predetermined dictionary D. The signal decomposition sub-module 552 uses the pixel vector in the cell as the given observed signal y, and calculates the corresponding sparse vector x with the optimum predetermined dictionary D using the formula above. Since an adjusted vector, i.e., a pixel vector, is an n×1-dimensional vector and the predetermined dictionary D calculated by the iteration module 530 is an n×m matrix, the sparse vector corresponding to the pixel vector calculated using the formula above is thus an m×1—dimensional vector.

The extraction module 560 is configured to extract an HOG feature of the image according to the sparse vectors.

In some embodiments, as shown in FIG. 5, the extraction module 560 includes a calculation sub-module 561, a first assembling module 562, and a second assembling module 563.

The calculation sub-module 561 is configured to calculate a gradient magnitude and a gradient direction for each of the cells according to the corresponding sparse vector, to thereby obtain a descriptor of the cell. Details of calculating the gradient magnitude and the gradient direction are described above with reference to FIG. 2A, and thus are not repeated here.

The first assembling sub-module 562 is configured to assemble the respective descriptors in each of the blocks to obtain the HOG feature of the block. Details of assembling the descriptors are described above with reference to FIG. 2A, and thus are not repeated here.

The second assembling sub-module 563 is configured to assemble the HOG features of respective blocks in the image to obtain the HOG feature of the image. Details of assembling the HOG features of the blocks are described above with reference to FIG. 2A, and thus are not repeated ehre.

FIG. 6 is a block diagram showing an example of the second assembling sub-module 563. As shown in FIG. 6, the second assembling sub-module 563 includes an adjustment sub-sub-module 610 and a feature extraction sub-sub-module 620.

The adjustment sub-sub-module 610 is configured to adjust the HOG feature of each of the blocks, which includes M×N pixels, in the image from an L×1-dimensional vector to an M×N matrix, where L=M×N. Details of adjusting the HOG features of the blocks are described above with reference to FIG. 3A, and thus are not repeated here.

The feature extraction sub-sub-module 620 is configured to obtain the HOG feature of the image according to the adjusted HOG features of the blocks and corresponding positions of the blocks in the image. Details of obtaining the HOG feature of the image are described above with reference to FIG. 3A, and thus are not repeated here.

Operations of the above-described exemplary devices are similar to the exemplary methods described above, and thus their detailed description is omitted here.

In an exemplary embodiment, a device for feature extraction is provided, which includes a processor and a memory storing instructions executable by the processor. The processor is configured to perform a method consistent with the present disclosure, such as one of the above-described exemplary methods.

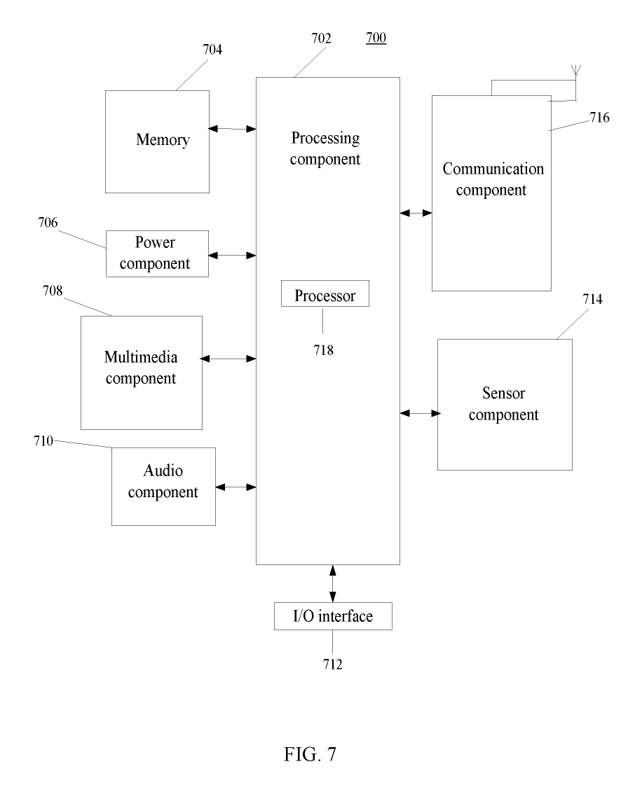

FIG. 7 is a block diagram of a device 700 for feature extraction according to another exemplary embodiment. For example, the device 700 may be a mobile phone, a computer, a digital broadcast terminal, a messaging device, a gaming console, a tablet, a medical device, exercise equipment, a personal digital assistant, or the like.

Referring to FIG. 7, the device 700 includes one or more of the following components: a processing component 702, a memory 704, a power component 706, a multimedia component 708, an audio component 710, an input/output (I/O) interface 712, a sensor component 714, and a communication component 716.

The processing component 702 typically controls overall operations of the device 700, such as the operations associated with display, telephone calls, data communications, camera operations, and recording operations. The processing component 702 may include one or more processors 718 to execute instructions to perform all or part of a method consistent with the present disclosure, such as one of the above-described exemplary methods. Moreover, the processing component 702 may include one or more modules which facilitate the interaction between the processing component 702 and other components. For example, the processing component 702 may include a multimedia module to facilitate the interaction between the multimedia component 708 and the processing component 702.

The memory 704 is configured to store various types of data to support the operation of the device 700. Examples of such data include instructions for any applications or methods operated on the device 700, contact data, phonebook data, messages, pictures, video, etc. The memory 704 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 706 provides power to various components of the device 700. The power component 706 may include a power management system, one or more power sources, and any other components associated with the generation, management, and distribution of power for the device 700.

The multimedia component 708 includes a screen providing an output interface between the device 700 and the user. In some embodiments, the screen may include a liquid crystal display (LCD) and a touch panel. If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 708 includes a front camera and/or a rear camera. The front camera and the rear camera may receive external multimedia data while the device 700 is in an operation mode, such as a photographing mode or a video mode. Each of the front camera and the rear camera may be a fixed optical lens system or have optical focusing and zooming capability.

The audio component 710 is configured to output and/or input audio signals. For example, the audio component 710 includes a microphone configured to receive an external audio signal when the device 700 is in an operation mode, such as a call mode, a recording mode, and a voice recognition mode. The received audio signal may be further stored in the memory 704 or transmitted via the communication component 716. In some embodiments, the audio component 710 further includes a speaker to output audio signals.

The I/O interface 712 provides an interface between the processing component 702 and peripheral interface modules, the peripheral interface modules being, for example, a keyboard, a click wheel, buttons, and the like. The buttons may include, but are not limited to, a home button, a volume button, a starting button, and a locking button.

The sensor component 714 includes one or more sensors to provide status assessments of various aspects of the device 700. For example, the sensor component 714 may detect an open/closed status of the device 700, relative positioning of components (e.g., the display and the keypad, of the device 700), a change in position of the device 700 or a component of the device 700, a presence or absence of user contact with the device 700, an orientation or an acceleration/deceleration of the device 700, and a change in temperature of the device 700. The sensor component 714 may include a proximity sensor configured to detect the presence of a nearby object without any physical contact. The sensor component 714 may also include a light sensor, such as a CMOS or CCD image sensor, for use in imaging applications. In some embodiments, the sensor component 714 may also include an accelerometer sensor, a gyroscope sensor, a magnetic sensor, a pressure sensor, or a temperature sensor.

The communication component 716 is configured to facilitate communication, wired or wirelessly, between the device 700 and other devices. The device 700 can access a wireless network based on a communication standard, such as WiFi, 2G, 3G, or 4G, or a combination thereof. In an exemplary embodiment, the communication component 716 receives a broadcast signal or broadcast associated information from an external broadcast management system via a broadcast channel. In an exemplary embodiment, the communication component 716 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth technology, or another technology.

In exemplary embodiments, the device 700 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing a method for feature extraction consistent with the present disclosure, such as one of the above-described exemplary methods.

In exemplary embodiments, there is also provided a non-transitory computer-readable storage medium including instructions, such as included in the memory 704, executable by the processor 718 in the device 700, for performing a method for feature extraction consistent with the present disclosure, such as one of the above-described exemplary methods. For example, the non-transitory computer-readable storage medium may be a ROM, a RAM, a CD-ROM, a magnetic tape, a floppy disc, an optical data storage device, or the like.

According to the present disclosure, the HOG feature of an image is extracted in the frequency domain using sparse vectors corresponding to cells of the image, rather than being calculated directly from the spatial domain of the image. Therefore, detection speed and accuracy in pattern recognition are improved.

Other embodiments of the invention will be apparent to those skilled in the art from consideration of the specification and practice of the disclosures herein. This application is intended to cover any variations, uses, or adaptations of the disclosure following the general principles thereof and including such departures from the present disclosure as come within known or customary practice in the art. It is intended that the specification and examples be considered as exemplary only, with a true scope and spirit of the invention being indicated by the following claims.

It will be appreciated that the inventive concept is not limited to the exact construction that has been described above and illustrated in the accompanying drawings, and that various modifications and changes can be made without departing from the scope thereof. It is intended that the scope of the invention only be limited by the appended claims.

What is claimed is:

1. A method for feature extraction, comprising:
partitioning an image into a plurality of blocks, each of the blocks including a plurality of cells;
performing a sparse signal decomposition on the cells using a predetermined dictionary to obtain sparse vectors respectively corresponding to the cells; and
extracting an image Histogram of Oriented Gradient (HOG) feature of the image according to the sparse vectors.

2. The method of claim 1, further comprising:
obtaining C sample images;
performing an iteration on the C sample images to obtain the predetermined dictionary, using the following formula:
min(R, D) ∥Y=DR∥F₂ subject to ∀i,∥mᵢ∥₀≦T₀
wherein:
R=[r₁, r₂, . . . , r_{C]} denotes a sparse coefficient matrix of the C sample images,
D denotes the predetermined dictionary,
Y denotes the C sample images,
∥•∥₀ , as applied to a vector, denotes calculating a number of non-zero elements in the vector,
T₀ denotes a predefined sparse upper limit, and
∥•∥_{F}, as applied to a vector, denotes calculating a square root of a sum of squares of elements of the vector.

3. The method of claim 1, wherein performing the sparse signal decomposition on the cells includes:
adjusting pixels in each of the cells to an n×1-dimensional pixel vector; and
performing, under the predetermined dictionary, the sparse signal decomposition on the pixel vector in each of the cells, to obtain the corresponding sparse vector, using the following formula:
min(x) ∥x∥₁ subject to y=Dx
wherein:
y denotes the pixel vector,
the predetermined dictionary D is an n×m matrix,
denotes the sparse vector, which is an m×1-dimensional vector, and
∥x∥₁ denotes a sum of absolute values of elements of the sparse vector x.

4. The method of claim 1, wherein extracting the image HOG feature includes:
calculating, according to the sparse vectors, a gradient magnitude and a gradient direction of each of the cells, to obtain a descriptor for each of the cells;
assembling the descriptors of the cells in each of the blocks to obtain a block HOG feature for each of the blocks;
assembling the block HOG features of the blocks in the image to obtain the image HOG feature.

5. The method of claim 4, wherein assembling the block HOG features to obtain the image HOG feature includes:
cascading the block HOG features into a matrix, to obtain the image HOG feature, each column of the matrix corresponding to the block HOG feature of one of the blocks.

6. The method of claim 4, wherein:
each of the blocks includes M×N pixels, and
assembling the block HOG features to obtain the image HOG feature includes:
adjusting the block HOG feature of each of the blocks from an initial L×1-dimensional vector to an M×N matrix, where L=M×N; and
obtaining the image HOG feature according to the adjusted block HOG features and corresponding positions of the blocks in the image.

7. The method of claim 1, further comprising:
normalizing the image to obtain a normalized image of a predetermined size.

8. A device for feature extraction, comprising:
a processor; and
a memory storing instructions that, when executed by the processor, cause the processor to:
partition an image into a plurality of blocks, each of the blocks including a plurality of cells;
perform a sparse signal decomposition on the cells using a predetermined dictionary to obtain sparse vectors respectively corresponding to the cells; and
extract an image Histogram of Oriented Gradient (HOG) feature of the image according to the sparse vectors.

9. The device of claim 8, wherein the instructions further cause the processor to:
obtain C sample images;
perform an iteration on the C sample images to obtain the predetermined dictionary, using the following formula:
min(R,D) ∥Y−DR∥_{F}² subject to ∀i,∥mᵢ∥₀≦T₀
wherein:
R=[r₁, r₂, . . , r_{C]} denotes a sparse coefficient matrix of the C sample images,
D denotes the predetermined dictionary,
Y denotes the C sample images,
∥•∥₀, as applied to a vector, denotes calculating a number of non-zero elements in the vector,
T₀ denotes a predefined sparse upper limit, and
∥•∥_{F},as applied to a vector, denotes calculating a square root of a sum of squares of elements of the vector.

10. The device of claim 8, wherein the instructions further cause processor to:
adjust pixels in each of the cells to an n×1-dimensional pixel vector; and
perform, under the predetermined dictionary, the sparse signal decomposition on the pixel vector in each of the cells, to obtain the corresponding sparse vector, using the following formula:
min (x) ∥x∥₁ subject to y=Dx
wherein:
y denotes the pixel vector,
the predetermined dictionary D is an n×m matrix,
denotes the sparse vector, which is an m×1-dimensional vector, and
∥x∥₁ denotes a sum of absolute values of elements of the sparse vector x.

11. The device of claim 8, wherein the instructions further cause processor to:
calculate, according to the sparse vectors, a gradient magnitude and a gradient direction of each of the cells, to obtain a descriptor for each of the cells;
assemble the descriptors of the cells in each of the blocks to obtain a block HOG feature for each of the blocks;
assemble the block HOG features of the blocks in the image to obtain the image HOG feature.

12. The device of claim 11, wherein the instructions further cause processor to:
cascade the block HOG features into a matrix, to obtain the image HOG feature, each column of the matrix corresponding to the block HOG feature of one of the blocks.

13. The device of claim 11, wherein:
each of the blocks includes M×N pixels, and
the instructions further cause processor to:
adjust the block HOG feature of each of the blocks from an initial L×1-dimensional vector to an M×N matrix, where L=M×N; and
obtain the image HOG feature according to the adjusted block HOG features and corresponding positions of the blocks in the image.

14. The device of claim 8, wherein the instructions further cause processor to:
normalize the image to obtain a normalized image of a predetermined size.

15. A non-transitory computer-readable storage medium having stored therein instructions that, when executed by a processor, cause the processor to:
partition an image into a plurality of blocks, each of the blocks including a plurality of cells;
perform a sparse signal decomposition on the cells using a predetermined dictionary to obtain sparse vectors respectively corresponding to the cells; and
extract an image Histogram of Oriented Gradient (HOG) feature of the image according to the sparse vectors.
